(19) United States
(12) Patent Application Publication
(10) Pub. No.: US 2017/0300789 A1
(43) Pub. Date: Oct. 19, 2017

(54) IMAGE PROCESSING APPARATUS, IMAGE PROCESSING METHOD, AND NON-TRANSITORY COMPUTER-READABLE MEDIUM

(71) Applicant: CANON KABUSHIKI KAISHA, Tokyo (JP)

(72) Inventor: Tatsuya Kikuyama, Chigasaki-shi (JP)

(21) Appl. No.: 15/485,110

(22) Filed: Apr. 11, 2017

(30) Foreign Application Priority Data
Apr. 15, 2016 (JP) 2016-082362

(51) Int. Cl. G06K 15/02

(52) U.S. Cl. CPC G06K 15/1813; G06K 15/1836; G06K 15/1861

(57) ABSTRACT

An image processing apparatus includes a reception unit configured to receive PDL data, an intermediate data generation unit configured to generate intermediate data on a basis of the received PDL data, a determination unit configured to determine units of generation for the intermediate data, and a transmission unit configured to transmit the intermediate data to a raster image generation unit configured to generate a raster image from the intermediate data each time the intermediate data is generated. The intermediate data includes edge information and filling information corresponding to an area surrounded by respective edges. The determination unit determines units of generation for the edge information and units of generation for the filling information. When the intermediate data generated by the generation unit is large, the units for the generation of the filling information are set to be larger than the units for the generation of the intermediate data.

### BACKGROUND OF THE INVENTION

### Field of the Invention

One disclosed aspect of the embodiments relates to an image processing apparatus, an image processing method, and a non-transitory computer-readable medium.

### Description of the Related Art

A method has been proposed in which raster image processor (RIP) processing for forming a raster image is performed by receiving data described in a page description language (PDL) (hereinafter, which will also be referred to as PDL data) via a network or the like and interpreting the PDL data by a dedicated-use interpreter, and printing processing is performed by a printer. In the RIP processing of the PDL, intermediate data is created on the basis of the information received from the interpreter, and a raster image is created in predetermined units (for example, for every plural scanlines or in units of a page).

For example, in a case where a page size is large as in a case where printing of a large-format size is performed, a size of the intermediate data also becomes large. When the size of the intermediate data is large in the RIP processing, a capacity stored on a memory also becomes large, and a cost of the memory is increased. It should be noted that a similar problem also occurs not only in a case where a printer of the large-format size is used but also a case where the memory is small with respect to the data size. In addition, since the data exceeding a memory capacity is not processed, an image quality is degraded in a case where the data amount is reduced.

In view of the above, according to Japanese Patent Laid-Open No. 2013-109748, a method of dividing an input image at a band height determined in accordance with a data transfer amount and a buffer capacity has been described.

However, according to Japanese Patent Laid-Open No. 2013-109748, the input image is merely divided to be processed, and the data amount is not decreased in terms of the page as a whole. Therefore, the size of the intermediate data is not decreased, and a time used for a communication becomes a bottleneck. A time from the start of generation of a raster image until the end of the generation becomes long, and a problem occurs that a printing performance is not exhibited.

### SUMMARY OF THE INVENTION

In view of the above-described circumstances, an image processing apparatus according to an aspect of the embodiments includes a reception unit configured to receive PDL data, an intermediate data generation unit configured to generate intermediate data on a basis of the PDL data received by the reception unit, a determination unit configured to determine units of generation for the intermediate data generated by the intermediate data generation unit, and a transmission unit configured to transmit the intermediate data generated by the generation unit to a raster image generation unit configured to generate a raster image from the intermediate data each time the intermediate data is generated by the generation unit, in which the intermediate data includes edge information and filling information corresponding to an area surrounded by respective edges, the determination unit further determines units of generation for the edge information and units of generation for the filling information, and in a case where the intermediate data generated by the generation unit is large, the determination unit sets the units of the generation for the filling information to be larger than the units of the generation for the intermediate data.

Further features of the disclosure will become apparent from the following description of exemplary embodiments with reference to the attached drawings.

### BRIEF DESCRIPTION OF THE DRAWINGS

FIG. 1 is a hardware configuration diagram illustrating an example of an image processing system configuration according to a first exemplary embodiment.

FIGS. 2A and 2B are software configuration diagrams illustrating an image processing system according to the first exemplary embodiment.

FIG. 3 is a function block diagram of an image processing apparatus according to the first exemplary embodiment.

FIG. 4 illustrates an example of drawing data.

FIG. 5 illustrates an example of a display list.

FIG. 6 illustrates an example of intermediate data in units of a page.

FIGS. 7A and 7B illustrate an example of intermediate data in units of a band.

FIG. 8 illustrates an intermediate data generation flow chart according to the first exemplary embodiment.

FIG. 9 illustrates an intermediate data generation flow chart according to a second exemplary embodiment.

FIG. 10 is a flow chart illustrating a first intermediate data generation processing example in units of the band according to the first exemplary embodiment.

FIG. 11 is a flow chart illustrating a second intermediate data generation processing example in units of the band according to the second exemplary embodiment.

FIG. 12 is a software configuration diagram illustrating the image processing system according to a third exemplary embodiment.

### DESCRIPTION OF THE EMBODIMENTS

### First Exemplary Embodiment

Hereinafter, exemplary embodiments will be described with reference to the drawings. It should be noted that the following exemplary embodiments are not intended to limit the disclosure, and also, all of combinations of features described according to the present exemplary embodiment are not necessarily needed for the disclosure.

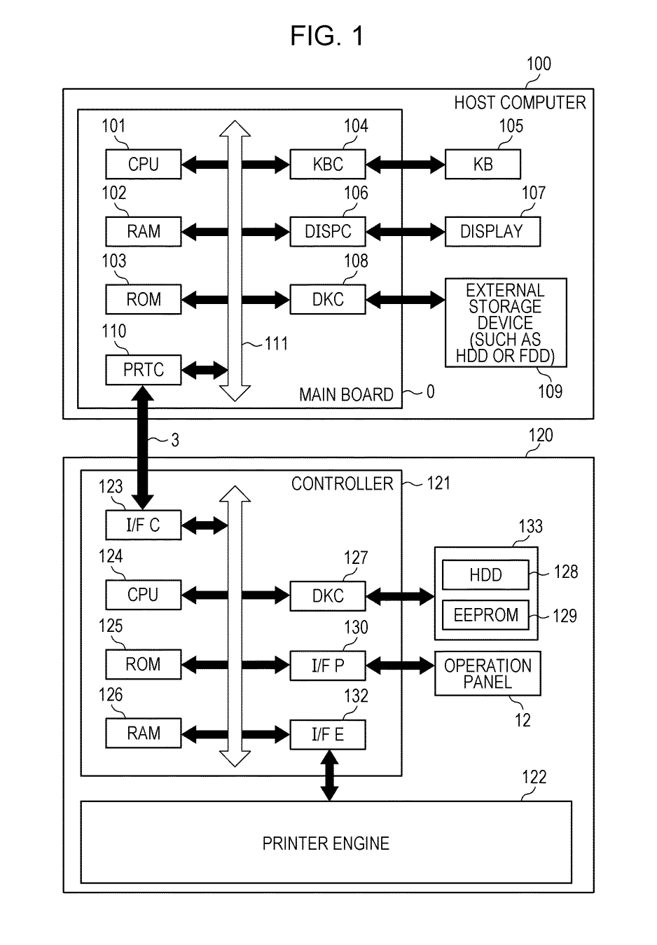

FIG. 1 is a block diagram illustrating a configuration of an image processing apparatus according to an exemplary embodiment.

FIG. 1 is a block diagram illustrating an outline of a printing system according to a first exemplary embodiment. As illustrated in FIG. 1, the printing system includes a host computer 100 and a printer 120. As illustrated in FIG. 1, the host computer 100 and the printer 120 are connected to each other via a network (bidirectional interface) 3.

The host computer 100 is an image processing apparatus, and a personal computer (PC) or the like is used as the host computer 100, for example. The host computer 100 may be an image server on the network or a PC including a printer driver. According to the present exemplary embodiment, an image processing system operating on a cloud environment will be described as an example.

The host computer 100 includes a main board 0, a key board (KB) 105, a display such as a liquid crystal display (LCD) (DISPLAY) 107, and an external storage device 109.

The main board 0 includes a CPU 101, a RAM 102, a ROM 103, a key board controller (KBC) 104, a display controller (DISPC) 106, a disc controller (DKC) 108, and a printer controller (PRTC) 110. These components are connected to one another via a system bus 111 on the main board 0.

The CPU 101 controls the above-described respective components connected to the system bus 111 in an overall manner and executes various programs stored in the ROM 103 or the like. The RAM 102 functions as a main memory or a work area of the CPU 101. The ROM 103 stores an operating system, programs for executing respective functions according to this exemplary embodiment, a boot program, various applications, a printer control command generation program (hereinafter, referred to as a printer driver), and the like.

The key board controller (KBC) 104 controls an input from the key board 105 or a pointing device that is not illustrated in the drawing. The key board controller 104 is also referred to as an operation unit or an input unit.

The display controller (DISPC) 106 controls display of the display 107 functioning as a display unit.

The disc controller (DKC) 108 controls an access between the main board 0 and the external storage device 109 such as a hard disc drive or a flexible disc drive (FDD).

The printer controller (PRTC) 110 is connected to the printer 120 via the network 3 and controls communication processing of data and commands with respect to the printer 120.

It should be noted that the host computer 100 according to the present exemplary embodiment can receive image data transmitted from a client computer, a mobile terminal, or the like. Although not illustrated in the drawing, the client computer can have a configuration similar to the host computer 100. The client computer and the mobile terminal are connected to the host computer 100 via the network.

For example, printing application is installed in the client computer, and the client computer can activate the printing application by using the CPU and the memory. An image saved in the client computer is selected or a layout image generated by laying out an image is selected in the printing application to determine an image of a printing target and execute a printing instruction. As a result, image data is transmitted from the printing application to the host computer 100 directly or via a server that is not illustrated in the drawing. Although a detail will be described below, the host computer 100 executes image processing, and thereafter, printing is executed by the printer 120. It should be noted that the image data may be data owned by the host computer 100 itself.

The printer 120 includes a controller 121, a printer engine 122, an operation panel 12, and a non-volatile storage device 133 and is connected to the host computer 100 via the bidirectional interface 3.

The operation panel 12 is provided with an operation unit and a display unit, and a touch panel is used as the operation panel 12, for example.

The non-volatile storage device 133 includes a hard disc (HDD) 128 and an EEPROM 129. The non-volatile storage device 133 may also be referred to as a non-volatile memory. It should be noted that, according to the present exemplary embodiment, the non-volatile storage device 133 includes the HDD 128 and the EEPROM 129, but the configuration is not limited to the above. For example, the non-volatile storage device 133 may include one of the HDD 128 and the EEPROM 129. The hard disc (HDD) 128 stores large-capacity data including data from a printer server 10 and ancillary information related to the data. The EEPROM 129 stores information unique to the printer used at the time of the printing operation or the like. According to the present exemplary embodiment, sheet information will be described as the information unique to the printer, for example.

The controller 121 includes a CPU 124, a ROM 125, a RAM 126, an interface controller (I/F C) 123, the disc controller (DKC) 127, a panel interface (I/F P) 130, and an engine interface (I/F E) 132. These components are connected to one another via a system bus in the controller 121.

The CPU 124 controls the above-described respective components connected to the system bus 111 in an overall manner and executes various programs stored in the ROM 103 or the like. The ROM 125 stores programs and various data for realizing optimal recording by receiving printing image data and a command from the host computer 100 and controlling the printer engine 122. The RAM 126 is used as a work area for temporarily storing various data and various programs.

The interface controller (I/F C) 123 is connected to the host computer 100 via the bidirectional interface 3 and controls processing of a communication with the host computer 100.

The disc controller (DKC) 127 controls an access to the non-volatile storage device 133. The panel interface (I/F P) 130 performs display control of the operation panel 12 and input control from the operation panel 12. The engine interface (I/F E) 132 controls the printer engine 122 that realizes the optimal recording by directly controlling the hardware.

The printer engine 122 prints an image on a sheet corresponding to a medium to be recorded by using various printing methods such as an inkjet method and an electrophotographic method on the basis of the image data.

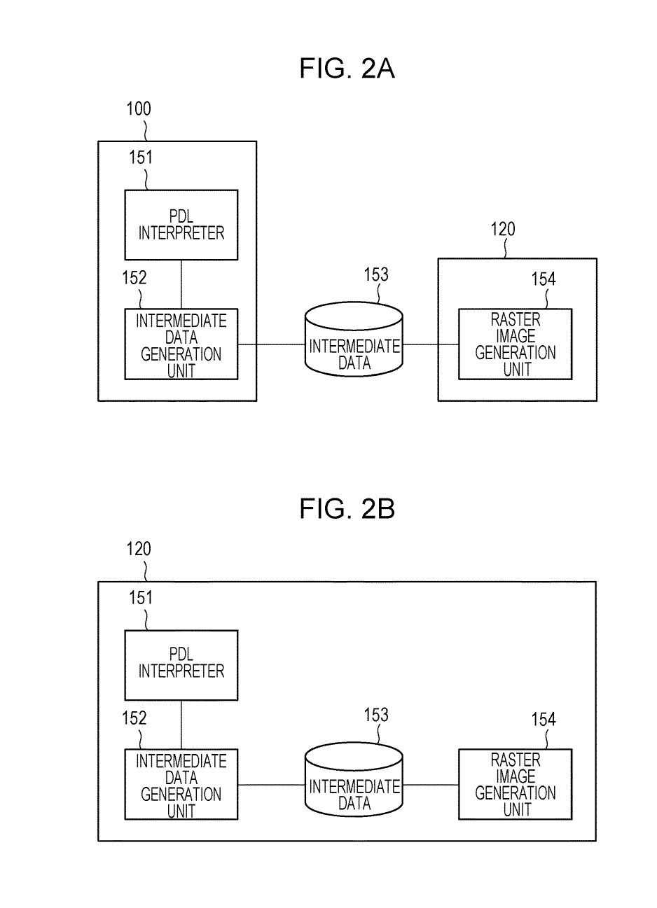

FIGS. 2A and 2B are software configurations of the printing system. According to the present exemplary embodiment, as illustrated in FIG. 2A, a configuration will be described in which the host computer 100 includes a PDL interpreter 151 and an intermediate data generation unit 152, and the printer 120 includes a raster image generation unit 154. According to the present exemplary embodiment, intermediate data 153 generated by the intermediate data generation unit 152 of the host computer 100 is transmitted to the printer 120 via the network or the like. That is, the raster image generation unit 154 is included in an external apparatus of the host computer 100.

It should be noted that the configuration according to the exemplary embodiment is not limited to the above. For example, as illustrated in FIG. 2B, the printer 120 may include all of the PDL interpreter 151, the intermediate data generation unit 152, and the raster image generation unit 154. The other image processing apparatus such as the host computer 100 may also include all of the PDL interpreter 151, the intermediate data generation unit 152, and the raster image generation unit 154. The PDL interpreter 151 receives an image formation command including an object drawing (image data) in a PDL format from printing application that is not illustrated in the drawing and interprets the image formation command in the PDL. The PDL interpreter 151 converts the interpreted image formation command into an object drawing command corresponding to an internal representation format to be transferred to the intermediate data generation unit 152. Herein, the PDL includes, for example, PostScript and PDF of Adobe Systems Incorporated and XPS of Microsoft Corporation but is not limited to the above.

The intermediate data generation unit 152 generates the intermediate data 153 from the object drawing command in predetermined units and outputs the intermediate data 153. It should be noted that the predetermined units include, for example, units of a page and units of a particular area (such as a width of a predetermined size and a block of a predetermined size). The intermediate data includes the image data representing the image, color information for identifying colors of the respective objects in the image, and edge information for identifying edges of the respective objects in the image. The intermediate data is format data that can be processed by the raster image generation unit 154.

The intermediate data 153 is transmitted to the raster image generation unit 154 of the printer 120 via a communication path such as the network. The raster image generation unit 154 generates a raster image on the basis of the information described in the intermediate data. As a result, it is possible to generate the raster image from the data described in the page description language (PDL).

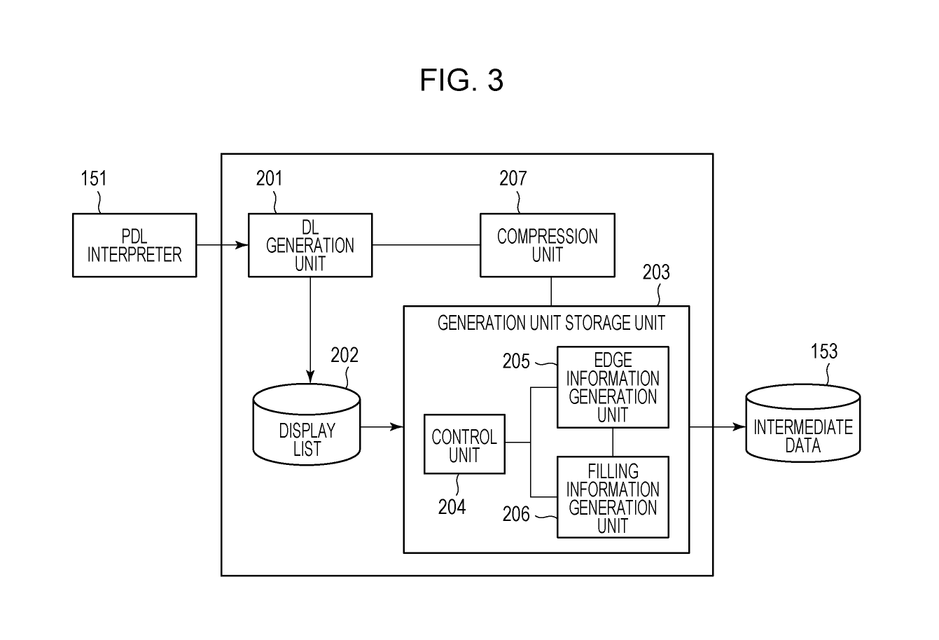

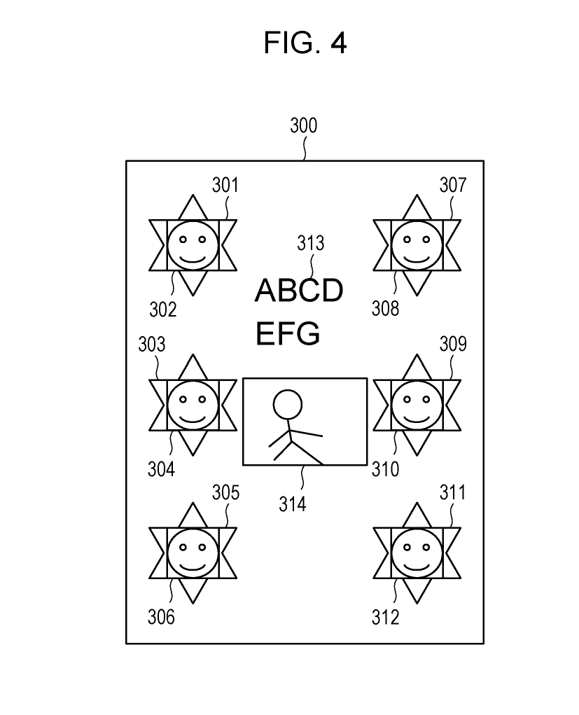

Here, processing of the intermediate data generation unit 152 will be described with reference to FIG. 3 and FIG. 4. FIG. 3 is a software block diagram illustrating a detail of the intermediate data generation unit 152, and FIG. 4 illustrates an example of a PDL drawing page corresponding to the intermediate data.

As illustrated in FIG. 3, the intermediate data generation unit 152 includes a DL generation unit 201, an intermediate data storage unit 203, and a compression unit 207.

The DL generation unit 201 functions as a display list generation unit. The DL generation unit 201 receives the image formation command interpreted by the PDL interpreter 151 as the object drawing command to be held in a format of a display list 202 and subsequently updated.

The intermediate data storage unit 203 includes a control unit 204, an edge information generation unit 205, and a filling information generation unit 206. The control unit 204 controls an entirety of the intermediate data storage unit 203. The control unit 204 reads a display list and determines units for the generation processing of the intermediate data. The edge information generation unit 205 generates edge information of an object in drawing data on the basis of the object drawing command. The filling information generation unit 206 generates filling information (color information) with respect to an area surrounded by the edge in the drawing data on the basis of the object drawing command.

Hereinafter, specific descriptions will be given with reference to a PDL drawing page of FIG. 4. Drawing data 300 in FIG. 4 is PDL page image data. The page image data is constituted by a plurality of object drawing commands, and the image formation commands are defined in the following order. Herein, the object drawing command refers to a command for arranging an object in the PDL (graphics, text or image object such as or photograph), and the image formation command refers to a command for the entire drawing page. In a graphics command 301, a star-shaped graphics command is defined, and filling in green (R =0, G=255, B=0) is defined. In an image object command 302, an image object command is defined and is overlapped with the graphics command 301 at a transparency of 70%. The drawing data 300 includes a plurality of object drawing commands that are the same as the graphics command 301 and the image object command 302. That is, the object drawing commands similar to the graphics command 301 and the image object command 302 are repeatedly defined in the drawing data 300. It should be noted that a graphics command 303, a graphics command 305, a graphics command 307, a graphics command 309, and a graphics command 311 have a configuration similar to the graphics command 301. In addition, an image object command 304, an image object command 306, an image object command 308, an image object command 310, and an image object command 312 have a configuration similar to the image object command 302. In this manner, the same object drawing command may be repeatedly defined when company logo representation in office documents, background patterns in album documents, and the like are combined with one another. In a case where the same image data is used in the PDL definition, a definition method varies depending on a specification of the PDL, and the definition may be repeatedly and individually performed in some cases, or the definition based on tile representation may be performed in other cases. A text command 313 specifies filling in black (R=0, G=0, B=0). The image object command is defined in the image object command 314. In this manner, the drawing data is obtained by combining the plurality of object drawing commands with one another.

Processing on the drawing data 300 of FIG. 4 will be described with reference to FIG. 3 again.

When the drawing data 300 is received, the PDL interpreter 151 interprets the image formation command to be transferred to the DL generation unit 201. The DL generation unit 201 receives the image formation command interpreted by the PDL interpreter 151 as the object drawing command to be held in a memory that is not illustrated in the drawing in the format of the display list 202 and subsequently updated. When the DL generation unit 201 receives the object drawing command with respect to the graphics command 301, for example, start coordinate points in the drawing data 300 of the graphics command, filling color, and overlapping information are added to the display list 202. Similarly, the consequent object drawing commands are subsequently added (updated) to the display list 202. According to the present exemplary embodiment, the drawing data 300 is data for one page, and the display list 202 is a list in which start coordinates of the respective objects are aligned in a Y direction while an upper left corner of the page is set as an origin.

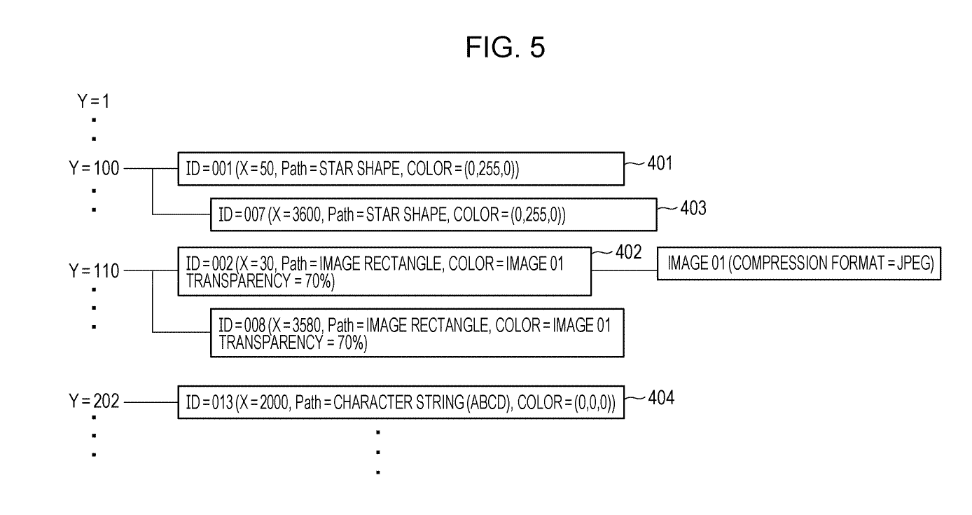

FIG. 5 illustrates a result of the display list 202 with respect to the drawing data 300. The object drawing commands of the drawing data 300 are sequentially listed in the Y direction of the page and in the order of a Z-order corresponding to a command order of the object drawing commands in the PDL. That is, according to the present exemplary embodiment, the object drawing commands are listed in the order of the commands instead of an arrangement location order of the object drawing commands to be aligned in the Y direction.

An object drawing command 401 of the display list 202 corresponds to the graphics command 301 and is added to a list part at 100 scanline (part at Y=100) corresponding to a Y coordinate of a start position of the object drawing command. Herein, an X coordinate in the page, path information representing a shape of the image, color information representing a color are registered as the object drawing command. The shape of the image includes a star shape, a rectangle, a curved line, a circle, and the like. In the case of a character string, “character string” is registered as the shape of the image. The color information includes image data insertion information such as a photogram (“image” in FIG. 5), RGB value, color space, and the like. In addition, the transparency and the like may be included as the color information.

The object drawing command 402 corresponds to the image object command 302 and is added to a list part at 110 scanline (part at Y=110). Since the image object command 302 is used to form the image object, the path information of the object drawing command 402 indicates a rectangular, and the color information includes “image” and “transparency of 70%”. The object drawing command includes a reference ID representing an entity of the image. According to the present exemplary embodiment, the entity of the image object is compressed by the compression unit 207 and stored in the display list 202. As a result, it is possible to reduce the size. A compression method for the image data in the compression unit 207 may be a lossless compression method, a lossy compression method, or a combination of both. A compression algorithm is not particularly limited, and a related-art compression algorithm can be used. According to the present exemplary embodiment, the object drawing command also includes information of a compression format.

The object drawing command 403 corresponds to the graphics command 307 and is added to the list at 100 scanline similarly as in the object drawing command 401. It should be noted however that a coordinate in an X direction is different from the object drawing command 401. The object drawing command 404 corresponding to the text command 313 is added to a list part at 250 scanline. This path information is set as a character string. In addition, according to the present exemplary embodiment, the path information includes content (ABCD) of the character string.

In this manner, the drawing information pieces of the respective image data are sequentially registered in the display list. The intermediate data 153 is generated by the consequent processing by the intermediate data generation unit 152 on the basis of the plurality of object drawing commands (drawing information) included in the display list 202.

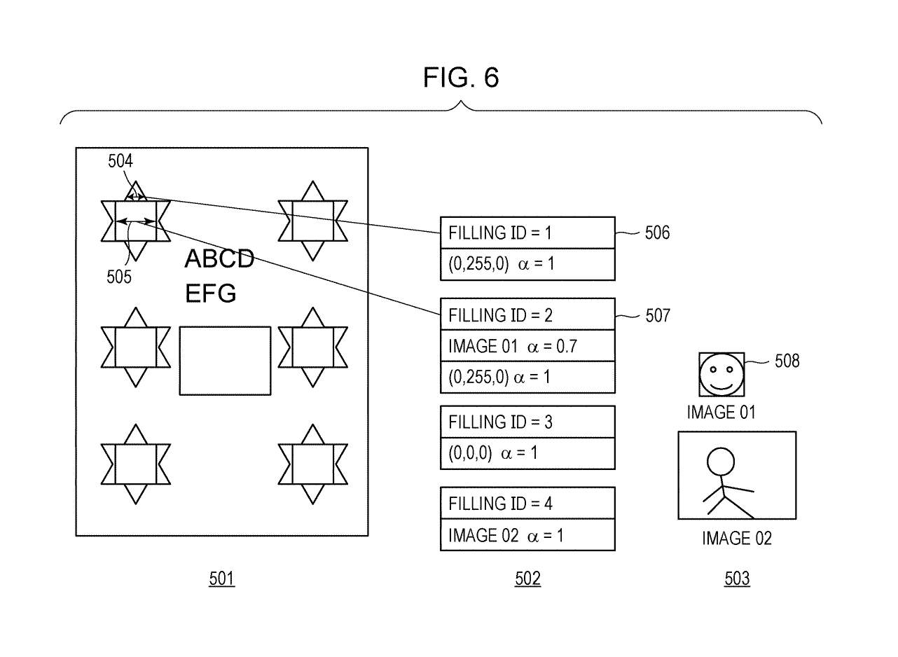

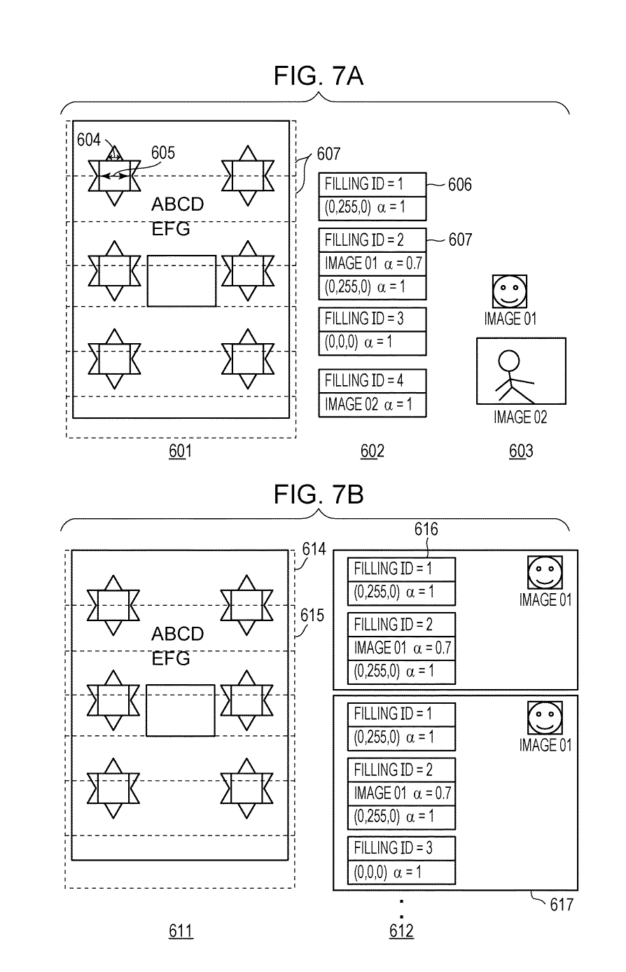

With reference to FIG. 6 and FIGS. 7A and 7B, the generation processing of the intermediate data 153 in the intermediate data storage unit 203 will be described. FIG. 6 illustrates the intermediate data generated in units of a page, and FIGS. 7A and 7B illustrate the intermediate data in units of a band.

The intermediate data generated in units of the page includes the edge information 501 and filling information 502. In addition, the intermediate data includes an image referred to from the filling information 502 as the image data 503. That is, according to the present exemplary embodiment, the intermediate data is constituted by the edge information 501, the filling information 502, and the image data 503, but the configuration is not limited to the above. The intermediate data may further include other information. The edge information 501 is information indicating an area where the filling information (color information) varies, and a boundary between the areas can be identified on the basis of overlapping of the object drawing commands. That is, the same filling information is applied to the single area. It should be noted that the edge information can also be regarded as information indicating the boundary area. The edge information includes coordinates of the boundary. A related-art method can be used as a method for the edge information.

The filling information 502 is information representing a color in which the object included in the page is filled. The filling information 502 includes identification information of the filling information (“filling ID” in the drawing) and the above-described color information and transparency information. It should be noted that the color is transparent in a case where a transparency α is 0, and the color is not transparent in the case where a transparency α is 1.

The respective components of the filling information 502 are respectively associated with the respective areas identified by the edge information 501, that is, the respective areas surrounded by the edges. For example, an area 504 indicates an area filled by filling information component 506, that is, an area filled in a single color of green (R=0, G=255, B=0). An area 505 indicates an area filled by filling information component 507.

The filling information component 507 indicates that the filling representing the image is overlapped on green at the transparency of 70%. The entity of the image object in the filling information component 507 is stored in the intermediate data as image data 508 in a storage area of the image data 503. At this time, the image data 508 may be stored in a compression format at the time of the storage in the display list 202 as it is or may be stored in a rasterized non-compression format. The respective areas in the next star-shaped graphics command and the next image object command also respectively refer to the filling information component 506 and the filling information component 507. In this manner, according to the present exemplary embodiment, in a case where the filling information is the same, the single filling information is stored without redundant storage. It should be noted that, in this case, the same filling information component (for example, the filling ID) is associated with respect to the different area.

The intermediate data generated in units of the band illustrated in FIGS. 7A and 7B includes the edge information, the filling information, and the image data similarly as in the page intermediate data illustrated in FIG. 6. Herein, the page size of the drawing data illustrated in FIGS. 7A and 7B is A4. The drawing data in the X direction is constituted by 4900 pixels, and the drawing data in the Y direction is constituted by 7014 pixels.

In FIG. 7A, the edge information 601 is generated in units of the band obtained by dividing the Y direction by a predetermined scanline number. Specifically, 1024 scanlines are set as one band, and the edge information is sequentially generated in units of 1024 lines. It should be noted that the units of the lines for one band are not limited to the above. Filling information 602 is generated in units larger than the units for the generation of the edge information 601. According to the present exemplary embodiment, the filling information is generated in units of the page.

In FIG. 7A, the filling ID=1 and the filling ID=2 are associated with respect to the star-shaped graphics command and the image object command. That is, in a case where the same filling information is used, the respectively corresponding pieces of filling information are associated with respect to the edge information, and the redundant filling information is not held.

While the above-described processing is repeatedly performed, in FIG. 7A, seven pieces of the edge information 601 generated in units of the 1024 scanlines (in units of the band) are generated (held), and the single filling information 602 is generated (held) for the page. Herein, in a case where the same drawing object is repeated, it is sufficient when one drawing object is generated since the filling information is the same. However, since the arrangement positions of the drawing objects are different from one another, the edge information is generated for each of the drawing objects. Each of the images such as a photograph associated with filling information 607 is stored in the intermediate data as the image data 603 in the compression format or the rasterized non-compression format similarly as in the intermediate data in units of the page illustrated in FIG. 6. In this manner, in FIG. 7A, the units of the edge information and the units of the filling information are set to be different from each other. Specifically, the edge information is held for each band, and the filling information is commonly provided for the page. As a result, it is possible to decrease the intermediate data for the page as a whole. In the example of FIG. 7B, both the edge information 611 and filling information 612 are generated in units of the 1024 scanlines (in units of the band). That is, the single filling information 612 is generated with respect to the single band. For example, filling information 616 becomes filling information corresponding to the edge information 614 (1024 scanlines in total). Similarly, filling information 617 corresponds to the edge information 615. While the intermediate data is generated in the above-described manner, the seven pieces of the intermediate data are provided for the page as a whole. In this manner, while the intermediate data is generated for each band, when the target raster image is processed, the processing does not need to wait until the intermediate data for one page can be generated.

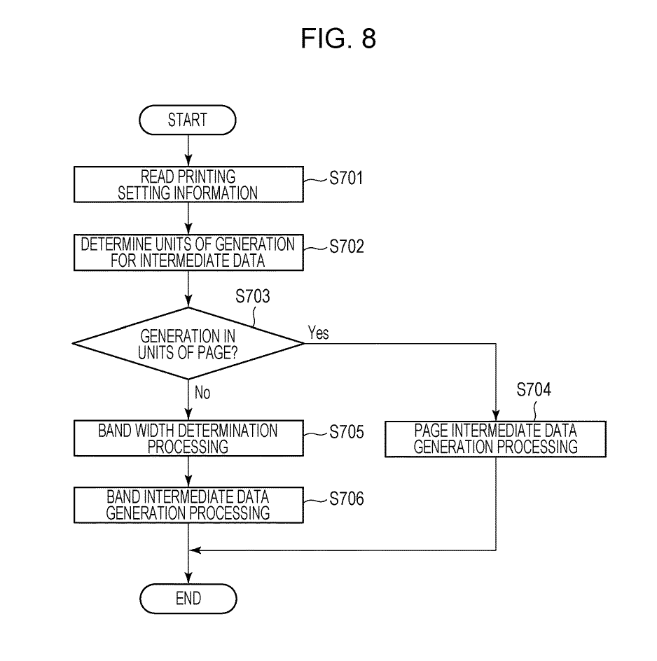

The intermediate data generation processing in the intermediate data storage unit 203 will be described in detail with reference to a flow chart. A flow chart of FIG. 8 is performed while the CPU 101 loads the image processing program stored in the ROM 103 into the RAM 102 to be executed. FIG. 8 illustrates a processing flow for statically determining units for the generation processing of the intermediate data.

In S701, the control unit 204 of the intermediate data storage unit 203 reads various printing setting information from the printing application. The printing setting information includes setting information such as an output sheet size, a resolution, and a magnifying scale. These pieces of setting information are specified, for example, while the user uses a screen provided by the printer driver of the client computer or the printing application displayed on the panel of the printer 120. In addition, the printing setting information includes a parameter obtained by interpreting the information in the PDL or the information defined by JDF by the PDL interpreter 151. In addition, at this time, performance information of the printer 120 may be obtained. For example, the performance information of the printer 120 includes capacity information of the memory that can be used by the raster image generation unit 154 included in the printer 120.

Next, the control unit 204 determines units for the generation of the intermediate data on the basis of the printing setting information read in S701. First, it is determined whether or not the size of the intermediate data becomes large on the basis of the printing setting information. That is, it is estimated whether or not the size of the intermediate data becomes large on the basis of the printing setting information. The units are set as units of the band in a case where it is determined that the size of the intermediate data becomes large, and the units are set as the units of the page in the other case. For example, when the output sheet size is large, the size of the intermediate data in units of the page becomes large. In a case where the output sheet size is larger than or equal to a threshold size (for example, A3 or larger), the generation of the intermediate data in units of the band is performed. In a case where the output sheet size is smaller than the threshold size (for example, a case where the size is smaller than A3), the units of the page are set as the units for the processing. In addition, the threshold size is changed, for example, in accordance with the output resolution. For example, in the case of 300 dots per inch (DPI), an A2 size is set as the threshold size, and in the case of 600 DPI, A3 is set as the threshold size. The determination may also be performed by reading a user specification of the units of the page or the units of the band. Moreover, in a case where the memory that can be used by the raster image generation unit 154 is large, the large intermediate data size can be stored. Therefore, the threshold size may be determined on the basis of the information of the memory that can be used by the raster image generation unit 154.

Then, in S703, it is determined whether the generation in units of the page is determined or the generation in units of the band is determined. In a case where the units for the generation of the intermediate data are determined as the units of the page in S703 (S703: Yes), the page intermediate data generation processing is executed in S704. In this case, both the edge information and the filling information are commonly saved for the page. That is, the single edge information and the single filling information are provided for the page.

In a case where the units for the generation are determined as the units of the band in S703 (S703: No), determination processing of a band width is executed in S705.

In S705, the units for the generation of the intermediate data, that is, the band width, are determined. At this time, the units for the generation of the edge information 601 and the filling information 602 are also determined. A determination method for the units for the generation of the intermediate data includes a method of directly leading a scanline number from a setting file or the like previously set in the ROM 103 of the host computer 100 and a calculation method by using the printing setting information read in S701. The calculation method from the printing setting information includes, for example, an obtaining method based on the number of pixels of the output sheet size. According to the present exemplary embodiment, the band width of the intermediate data is set as the units for the generation of the edge information 601. On the other hand, the units for the generation of the filling information 602 are set to be larger than the band width of the intermediate data. For example, in the case of the A4 size, the units for the generation of the edge information 601 are set as units of the band (herein, units of 512 scanlines), and the units for the generation of the filling information 602 are set as the units of the page (units of 7140 scanlines). In the case of the A3 size, the units for the generation of the edge information 601 and the filling information 602 are respectively half of those in the case of the A4 size. That is, the units for the generation of the edge information 601 are set as units of 256 scanlines, and the units for the generation of the filling information 602 are set as units of 3600 scanlines. In this manner, the units for the generation of the filling information are set to be larger than the units for the generation of the edge information 601. It should be noted that the determination method for the units for the generation of the filling information 602 is not limited to the above. The units for the generation of the filling information 602 may be set as the units of the page irrespective of the sheet size. Furthermore, the units for the generation may be changed in accordance with the performance of the raster image generation unit 154. That is, the units for the generation are changed in accordance with a model of the printer 120 including the raster image generation unit 154. For example, with regard to the units for the generation in the case of the same A4 size, the units for the generation in the case of the memory capacity at 50 MB are set as a value larger than those in the case of the memory capacity at 25 MB. In a case where the memory capacity is 25 MB, the units for the generation of the edge information 601 and the filling information 602 are respectively set as units of 256 scanlines and units of 3600 scanlines which are respectively half of those in the case of the memory capacity at 50 MB.

When the band width is determined in the processing in S705, the intermediate data generation processing is executed in S706 in units of the band. According to the present exemplary embodiment, the intermediate data is generated in units of the band, and the filling information is generated in units of the page. In this manner, the units for the processing of the filling information are larger than the units for the processing of the intermediate data.

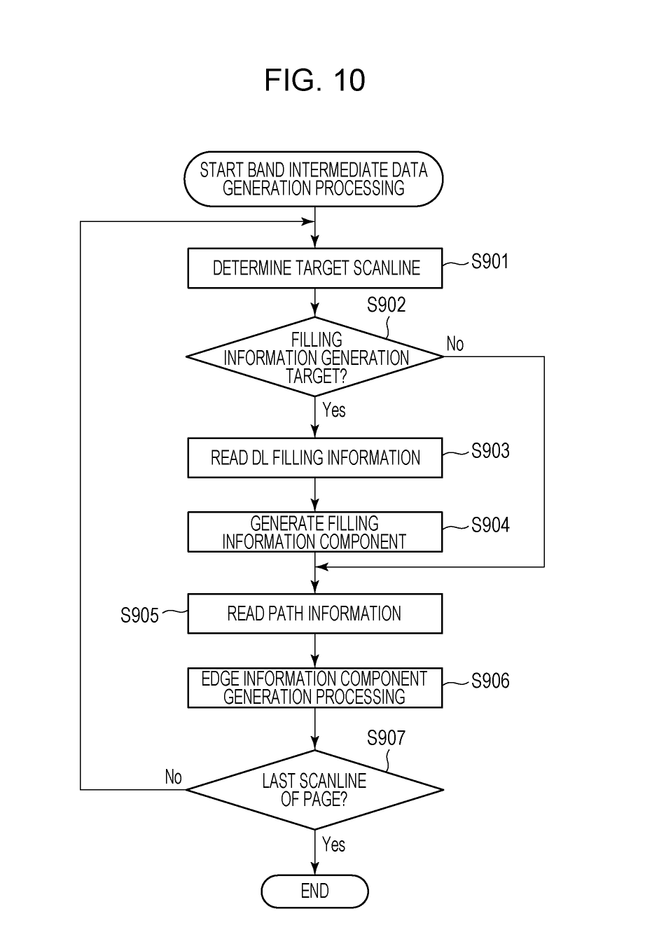

It should be noted that, according to the present exemplary embodiment, the intermediate data is set in units of the band, but the configuration is not limited to the above. Units of a tile may be set in which the X direction (horizontal direction of FIGS. 7A and 7B) and the Y direction are divided into plural pieces. In this case, in S705, it is determined that the intermediate data and the edge information are generated in units of the band, and the filling information is generated in units of the page. FIG. 10 is a flow chart of the intermediate data generation processing in units of the band in S706. Herein, a case will be described as an example where the edge information 601 is generated in units of 512 scanlines, and the filling information 602 is generated in units of 3600 scanlines.

The control unit 204 of the intermediate data storage unit 203 obtains the target scanline of the intermediate data generated in S901. Since the units are the units of 512 scanlines, the target scanlines correspond to scanlines 1 to 511 at the beginning. In S902, it is determined whether or not the target scanlines are the generation target of the filling information 602. The beginning of the page is set as the target of the filling information, and the target is thereafter set for every 3600 scanlines.

In a case where the target of the filling information is not set in S902, the flow proceeds to S905.

In a case where the target of the filling information is set in S902 (S902: Yes), the filling information generation unit 206 generates all the filling information in the target scanlines of the filling information 602. First, in S903, the filling information generation unit 206 reads filling information of objects from 1 to 3600 corresponding to the target scanlines from the display list 202. Next, in S904, the filling information 602 of the intermediate data is generated on the basis of the filling information of the objects. As illustrated in FIGS. 7A and 7B, the filling information of the filling information 602 includes filling colors of the respective edges, an image ID indicating an entity of the image, and a transparency. Herein, the filling information 602 includes only one piece of information with regard to the same color and the same image.

In S905, the edge information generation unit 205 reads the path information of the display list 202 corresponding to the target of the edge generation. In S906, the edge information generation unit 205 performs edge generation processing. In the edge generation processing, boundaries set by taking into account the overlapping of the respective objects located on the target scanlines are set as the edges, and these pieces of arrangement information are generated as the edge information. Specifically, the edges are generated so as to section an area to which the filling information is applied. As a result, the area is sectioned for each filling information. As in an area 604 of FIGS. 7A and 7B, each area identified by the edge information is associated with a reference value of one filling information component 606 among the filling information 602. In addition, with regard to the edge information, while a predetermined square area is set as a tile, the edge information can be generated for each tile. For example, the edge information is generated in units of the tile having 64 pixels in both the X direction and the Y direction, and the size of the generated edge information can be reduced by the lossless compression. While the processing of creating the edge information in units of the tile is repeatedly performed, the plural pieces of edge information 602 corresponding to 512 scanlines are generated. In S907, it is determined whether or not the generated edge information is the end of the page. In a case where the generated edge information is the end of the page (S907: Yes), the intermediate data generation processing is ended. In a case where the generated edge information is not the end of the page (S907: No), the flow returns to S901 to continue the processing.

As a result, the intermediate data generation processing for one page is performed. In the case of a document constituted by a plurality of pages, this flow is repeatedly executed for the number of pages. According to the present exemplary embodiment, each time the intermediate data is generated, the intermediate data generation unit 152 transmits the intermediate data to the raster image generation unit 154. That is, in a case where the intermediate data is generated in units of the band, the intermediate data is transmitted in units of the band. Therefore, before the intermediate data of the page as a whole is generated, at least the intermediate data at the first band is transmitted to the raster image generation unit 154. In addition, the intermediate data generation unit 152 deletes the intermediate data from the memory each time the intermediate data is transmitted to the raster image generation unit 154.

Next, the raster image generation processing in the raster image generation unit 154 will be described. When the intermediate data in units of the band is received, the filling information 602 is stored in a memory that is not illustrated in the drawing included in the raster image generation unit 154. It should be noted that the intermediate data in units of the band holds the edge information in units of the band. Then, the raster image generation processing is executed with respect to the intermediate data in units of the band. Specifically, the raster image generation unit 154 sequentially rasterizes the edge information 601 for each scanline and executes overlapping processing of overlapping the respective components of the filling information 602 corresponding to each area divided by the edge information with each other to determine a color for each area divided by the edge information. At this time, in a case where a reference is made to the image ID included in the filling information, the image data corresponding to the image ID stored in the compression or non-compression format is rasterized, and the overlapping is thereafter executed to identify the color of the area surrounded by the corresponding edge. The area surrounded by the edge is sequentially filled in the color identified by the overlapping (applying the color the edge area), so that the raster image can be obtained. While the intermediate data in units of the band is received and the raster image generation processing in units of the band is repeatedly performed, the raster image for one page can be generated. Herein, the filling information 602 stored in the memory included in the raster image generation unit 154 is held in the memory until the generation of the raster image for the target scanline is ended.

According to the present exemplary embodiment, in a case where the size of the intermediate data becomes large, when the intermediate data is generated, the edge information is set in units of the band, and the filling information is set in units of the page. As a result, it is possible to reduce the data amount per page of the intermediate data.

The intermediate data generated in units of the band is transmitted to the raster image generation unit 154. As a result, the already transmitted information can be deleted from the memory of the intermediate data generation unit 152, and it is possible to reduce the memory for saving the intermediate data. That is, it is possible to suppress the size of the memory area for saving the generated intermediate data.

In addition, according to the present exemplary embodiment, while the intermediate data is transmitted in units of the band to the raster image generation unit 154, the raster image generation unit 154 can start the raster image generation processing earlier as compared with a case where the intermediate data is transmitted in the units of the page to the raster image generation unit 154. Moreover, for example, in the raster image generation processing in which much memory is needed as in the case of the large-format image too, it is possible to suppress the size of the memory area for saving the received intermediate data of the raster image generation unit 154.

### Second Exemplary Embodiment

According to the first exemplary embodiment, the intermediate data is determined on the basis of the printing setting information, but according to the present exemplary embodiment, the generation processing of the intermediate data is dynamically determined. It should be noted that descriptions overlapped with the descriptions on the first exemplary embodiment will be omitted. In addition, the same components as those according to the first exemplary embodiment are assigned with the same reference symbols.

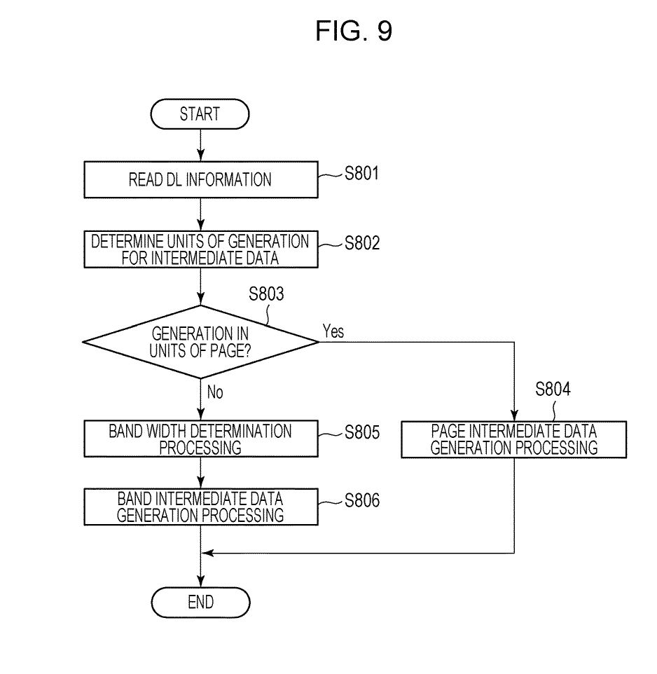

FIG. 9 is a flow for dynamically determining the units for the generation processing of the intermediate data according to the present exemplary embodiment. A flow chart of FIG. 9 is executed while the CPU 101 loads the image processing program stored in the ROM 103 into the RAM 102 and executes the image processing program.

The control unit 204 of the intermediate data storage unit 203 reads the information of the display list 202 generated by the DL generation unit 201 in S801.

Next, in S802, the control unit 204 determines the units for the generation of the intermediate data from the information of the display list 202 read in S801. First, it is determined whether or not the size of the intermediate data becomes large on the basis of the information of the display list 202. That is, it is expected whether or not the size of the intermediate data becomes large on the basis of the information of the display list 202. Then, the units of the band are determined in a case where it is determined that the size of the intermediate data becomes large, and the units of the page are determined in other cases. The display list information referred to in S802 includes the total number of the objects for each page (such as graphics, texts, and image objects), the number of the image objects, the total area of the image objects, and the like. When the total number of objects is high, the size of the intermediate data of the page as a whole becomes large. In view of the above, according to the present exemplary embodiment, in a case where the total number of objects is 10000 or higher, the generation of the intermediate data in units of the band is determined. In addition, in either a case where the number of the image objects is high or a case where the total area of the image objects is large, the filling information becomes large, and there is a tendency that the size of the intermediate data of the page as a whole becomes large. In view of the above, according to the present exemplary embodiment, in a case where the number of the image objects is 1000 or higher, the generation of the intermediate data in units of the band is determined. In a case where the number of pixels of all the image objects is 8 million (8 M) or higher, the generation of the intermediate data in units of the band is determined. According to the present exemplary embodiment, it is determined whether or not one or more of the following conditions are satisfied in which the total number of objects is higher than or equal to an object threshold (10000 or higher), the number of the image objects is higher than or equal to an image object threshold (1000 or higher), and the total area of the image objects is higher than or equal to an threshold (8 M pixels or larger). In a case where one or more of these conditions are satisfied, the generation of the intermediate data in units of the band is determined. In a case where none of the conditions are satisfied, the generation of the intermediate data in units of the page is determined. It should be noted that, according to the present exemplary embodiment, the determination on whether or not the three conditions are satisfied is performed, but the configuration is not limited to the above. It may be determined whether or not one or two of these conditions are satisfied, or other conditions may also be used for the determination.

Then, in S803, it is determined whether the generation in units of the page is determined or the generation in units of the band is determined. In a case where the intermediate data generation in units of the page is determined (S803: Yes), the intermediate data generation in units of the page is performed in S804. In a case where the intermediate data generation processing in units of the band is determined, the flow proceeds to S805.

In S805, the units for the generation of the intermediate data, that is, the band width, are determined. At this time, the units for the generation of the edge information 601 and the filling information 602 are also determined. Specifically, the units for the processing of the intermediate data are determined on the basis of the DL information referred to in S802. According to the present exemplary embodiment, the band width of the intermediate data is set as the units for the generation of the edge information 601. On the other hand, the units for the generation of the filling information 602 are set to be larger than the band width of the intermediate data. For example, in a case where the total number of objects is higher than or equal to 10000 and lower than or equal to 20000, the units for the processing of the edge information 601 are set as units of the 1024 scanlines, and the units for the processing of the filling information 602 are set as the units of the page. In a case where the total number of objects is higher than or equal to 20000 and lower than or equal to 40000, the units for the processing of the edge information 601 are set as the units of 512 scanlines, and the units for the processing of the filling information 602 are set as the units of 3600 scanlines. Herein, the descriptions have been given while the total number of objects is used as an example, but the units for the processing of the edge information 601 and the units for the processing of the filling information 602 are similarly determined in accordance with the number of the image objects and the total area of the image objects.

When the band width for the processing is determined in S805, the generation processing of the band intermediate data is executed in S806.

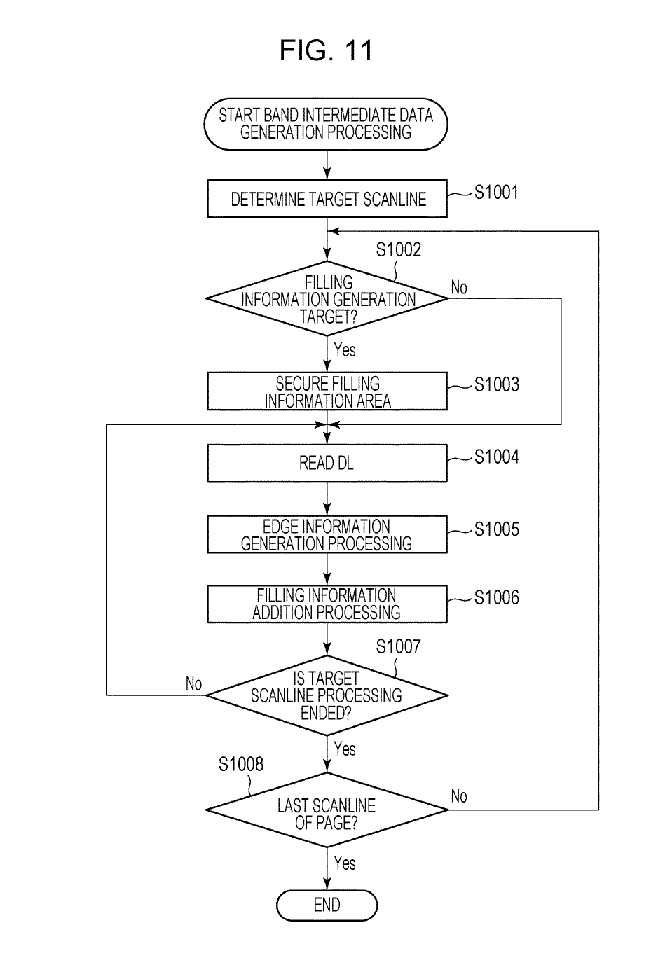

FIG. 11 is a flow chart for performing the generation of the intermediate data in units of the band. In S1001, the control unit 204 of the intermediate data storage unit 203 determines the target scanline. It should be noted that the determination method for the target scanline is similar to S901. Then, when the target scanline is read, it is determined in S1002 whether or not the target scanline is the generation target of the filling information 602. In a case where it is determined that the target scanline is not the generation target of the filling information (S1002: No), the flow proceeds to S1004. In a case where it is determined that the target scanline is the generation target of the filling information (S1002: Yes), in S1003, an area of the filling information 602 is secured on the memory of the host computer 100. The size of the secured area may be a fixed size or a variable size such as a size in proportion to the output page size.

In S1004, reading of the display list 202 is performed in units of the tile, that is, for the processing target tile. Next, in S1005, the edge information generation unit 205 performs the generation processing of the edge information 601 for the processing target tile. In S1006, the filling information generation unit 206 executes addition processing of adding the filling information corresponding to the edge information 601 for the processing target tile to the area secured in S1003.

In S1007, it is determined whether or not the target scanline processing is ended. Herein, since the target scanlines are 512 lines, it is determined whether or not the number reaches 512. In a case where the number does not reach the number of the target scanlines (512 lines), that is, in a case where it is determined that the target scanline processing is not ended (S1007: No), the flow returns to S1004 to repeat the processing. In a case where the number reaches the number of the target scanlines (512 lines), that is, in a case where it is determined that the target scanline processing is ended (S1007: Yes), it is determined whether or not the scanline is the last scanline in the page in S1008. In a case where it is determined that the scanline is the last scanline in the page (S1008: Yes), the processing is ended. In a case where it is determined that the scanline is not the last scanline in the page (S1008: No), the flow returns to S1002 to repeat the processing.

It should be noted that, according to the present exemplary embodiment, the units for the generation of the filling information are fixed (the units of the page), but the configuration is not limited to the above. The units for the generation of the filling information may also be variable. In this case, in S1002, a current size of the filling information 602 is checked, and when the current size is close to the secured size, it is determined that the units for the generation are to be changed. That is, since there is a possibility that the filling information generated in the units for the generation may be larger than the size secured in the memory, it is determined that the filling information is created in the units for the generation smaller than the current units for the generation. That is, the generation may be performed after the division in accordance with the size of the filling information 602. As a result, the intermediate data generation processing for one page is performed. In the case of a document constituted by a plurality of pages, this flow is repeatedly executed for the number of pages.

According to the present exemplary embodiment, each time the intermediate data is generated, the intermediate data generation unit 152 transmits the intermediate data to the raster image generation unit 154. That is, in a case where the intermediate data is generated in units of the band, the intermediate data is transmitted in units of the band. Therefore, before the intermediate data of the page as a whole is generated, at least the intermediate data at the first band is transmitted to the raster image generation unit 154. In addition, the intermediate data generation unit 152 deletes the intermediate data from the memory each time the intermediate data is transmitted to the raster image generation unit 154.

It should be noted that the operation of the raster image generation unit 154 is similar to the first exemplary embodiment, and descriptions thereof will be omitted.

According to the present exemplary embodiment, in a case where the size of the intermediate data becomes large, when the intermediate data is generated, the edge information is set in units of the band, and the filling information is set in units of the page. As a result, it is possible to reduce the data amount per page of the intermediate data.

In addition, the intermediate data generated in units of the band is transmitted to the raster image generation unit 154. As a result, the already transmitted information can be deleted from the memory of the intermediate data generation unit 152, and the memory for saving the intermediate data can be reduced. That is, it is possible to suppress the size of the memory area for saving the generated intermediate data.

Moreover, according to the present exemplary embodiment, while the intermediate data is transmitted to the raster image generation unit 154 in units of the band, the raster image generation unit 154 can start the raster image generation processing earlier as compared with a case where the intermediate data is transmitted in units of the page to the raster image generation unit 154. Furthermore, for example, in the raster image generation processing in which much memory is needed as in the case of the large-format image too, it is possible to suppress the size of the memory area for saving the received intermediate data of the raster image generation unit 154.

It should be noted that one memory that saves the generated intermediate data may be used in a case where the single image processing apparatus includes the intermediate data generation unit 152 and the raster image generation unit 154 as illustrated in FIG. 2B, but similarly, it is possible to suppress the size of the memory area.

### Third Exemplary Embodiment

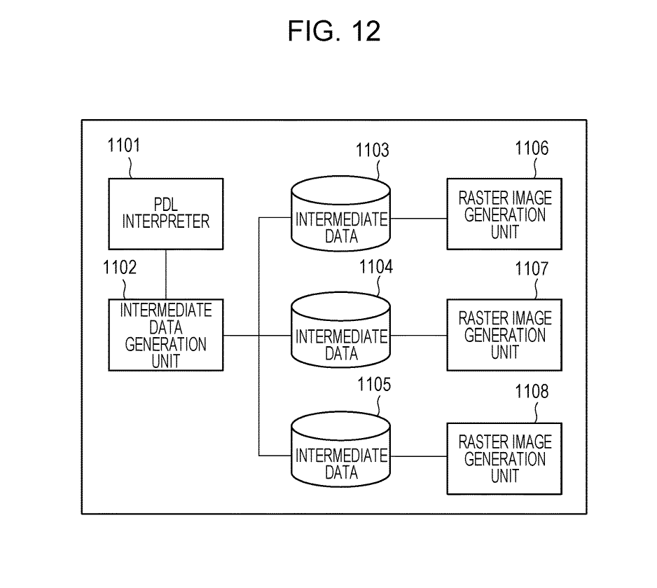

According to the present exemplary embodiment, a plurality of raster image generation processing units are provided, and parallel processing of the raster image generation can be executed. FIG. 12 is a block diagram illustrating a configuration of the image processing system according to the present exemplary embodiment. The image processing system according to the present exemplary embodiment includes a PDL interpreter 1101, an intermediate data generation unit 1102, and three raster image generation processing units 1106, 1107, and 1108. The intermediate data 1103, 1104, and 1105 are respectively stored in memories. The respective raster image generation processing units independently hold the respective pieces of the processing target intermediate data, so that the raster image generation processing can be performed without accessing a shared memory. It should be noted that the configuration of each of the raster image generation units is similar to the raster image generation unit 154 according to the first exemplary embodiment except for a difference in the processing target intermediate data.

According to the present exemplary embodiment, for example, the raster image generation for one page is executed by the plurality of raster image generation units. Herein, the processing targets of the respective image generation processing units are mutually different areas of the page. According to the present exemplary embodiment, the intermediate data for one page is divided into three pieces of the intermediate data, and the respective pieces of the intermediate data are processed in the different image generation processing units. Therefore, the edge information 601, the filling information 602, and the image data 603 are divided into three or more pieces. In the determination of the units for the generation of the intermediate data in S702 of FIG. 8, the units for the processing are set as a value in accordance with a parallel number. For example, in a case where the three image generation processing units execute the processing, that is, the parallel number is 3 and the A4 page is processed, the intermediate data is generated for every 2338 scanlines obtained by dividing 7014 scanlines for one page by the parallel number. It should be noted that the units for the generation of the intermediate data are not limited to the above. The units may also be set as a number obtained by dividing the scanlines by an integral multiple of the parallel number. For example, similarly as in S702, it is determined whether or not the size of the intermediate data becomes large on the basis of the printing setting information. In a case where it is determined the size becomes large, a number twice, three times, . . . , as high as the parallel number may be determined, for example. In addition, the size of the intermediate data may be determined in accordance with the memory capacity corresponding to each of the raster image generation units, for example. Thereafter, the units for the processing of the edge information and the filling information may be determined by a method similar to S705, and the units for the processing of the edge information and the filling information may be set as the same as the units for the generation processing of the intermediate data.

With regard to the intermediate data generated after the division, the respective raster image generation processing units execute the raster image generation processing for each target scanline. The respective raster image generation processing units write the generated raster images to the corresponding page memories, so that the raster image generation for the page is performed. It should be noted that the plurality of raster image generation units may be included in a single apparatus, or one or more raster image generation units may be included in each of a plurality of apparatuses.

According to the present exemplary embodiment, the intermediate data in the same units are allocated to the plurality of raster image generation units to be processed, but the configuration is not limited to the above. The intermediate data in different units may be allocated to each of the raster image generation processing units to be processed. For example, the processing performance may vary for each raster image generation processing unit in some cases such as a case where the image processing system includes the raster image generation processing unit constituted by software and the raster image generation processing unit constituted by hardware. In this case, the units for the division of the intermediate data may be changed in accordance with the performance of the raster image generation processing unit. For example, in a case where a processing speed of the raster image generation processing unit constituted by the hardware (HW) is twice as fast as a processing speed of the raster image generation processing unit constituted by the software (SW), the raster image generation processing unit constituted by the HW can process the intermediate data more in the same period of time. Specifically, with regard to the filling information 602 of the intermediate data, the raster image generation processing unit constituted by the HW can process the band intermediate data for the number of scanlines twice as many as that processed by the raster image generation processing unit constituted by the SW. Therefore, the units for the processing of the filling information 602 can also be set as twice as high.

According to the present exemplary embodiment, while the intermediate data of the different area is allocated to each of the raster image generation processing units, it is possible to perform the raster formation processing at a high speed without generating shared memory accesses.

### Other Exemplary Embodiments

The disclosure is not limited to the above-described exemplary embodiments. For example, according to the first exemplary embodiment, the band intermediate data may be generated by the flow chart illustrated in FIG. 11 according to the second exemplary embodiment. In addition, according to the second exemplary embodiment, the band intermediate data may be generated by the flow chart illustrated in FIG. 10 according to the first exemplary embodiment.

Moreover, according to the above-described exemplary embodiments, in a case where the generated intermediate data is large, the units for the generation of the intermediate data are set as the units of the band, and in a case where the generated intermediate data is not large, the units for the generation of the intermediate data are set as the units of the page, but the configuration is not limited to the above. That is, irrespective of the size of the generated intermediate data, the units for the generation of the intermediate data may be set as the units of the band. In this case too, the units for the generation of the filling information are set to be larger than the units for the generation of the intermediate data.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. According to the exemplary embodiments of the disclosure, the size of the intermediate data can be reduced, and it is possible to perform the image processing at the high speed.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2016-082362 filed Apr. 15, 2016, which is hereby incorporated by reference herein in its entirety.

What is claimed is:

1. An image processing apparatus comprising:
a reception unit configured to receive page description language (PDL) data;
an intermediate data generation unit configured to generate intermediate data on a basis of the PDL data received by the reception unit;
a determination unit configured to determine units of generation for the intermediate data generated by the intermediate data generation unit; and
a transmission unit configured to transmit the intermediate data generated by the generation unit to a raster image generation unit configured to generate a raster image from the intermediate data each time the intermediate data is generated by the generation unit,
wherein the intermediate data includes edge information and filling information corresponding to an area surrounded by respective edges,
wherein the determination unit further determines units of generation for the edge information and units of generation for the filling information, and
wherein, in a case where the intermediate data generated by the generation unit is large, the determination unit sets the units of the generation for the filling information to be larger than the units of the generation for the intermediate data.

2. The image processing apparatus according to claim 1, wherein the determination unit sets the units for the generation of the edge information to be the same as the units for the generation of the intermediate data.

3. The image processing apparatus according to claim 1, wherein, in a case where the intermediate data generated by the generation unit is large, units for processing of the intermediate data are set as units of a band, and units for processing of the filling information are set as units of a page.

4. The image processing apparatus according to claim 1, wherein, in a case where the intermediate data generated by the generation unit is large, units for processing of the intermediate data are set as units of a tile, and units for processing of the filling information are set as units of a page.

5. The image processing apparatus according to claim 1, further comprising:
a determination unit configured to determine whether or not the intermediate data generated by the generation unit is large,
wherein, in a case where the determination unit determines that the intermediate data is large, the units for the generation of the filling information are set to be larger than the units for the generation of the intermediate data, and in a case where the determination unit determines that the intermediate data is not large, the units for the generation of the filling information are set to be the same as the units for the generation of the intermediate data.

6. The image processing apparatus according to claim 5, wherein the determination unit determines whether or not the intermediate data generated by the generation unit is large on a basis of the number of objects included in the PDL data.

7. The image processing apparatus according to claim 5, wherein the determination unit determines whether or not the intermediate data generated by the generation unit is large on a basis of printing setting information.

8. The image processing apparatus according to claim 1, further comprising:
the raster image generation unit.

9. The image processing apparatus according to claim 1, wherein an external apparatus includes the raster image generation unit.

10. An image processing method comprising:
receiving page description language (PDL) data;
generating intermediate data on a basis of the received PDL data;
determining units of generation for the intermediate data to be generated in the generating; and
transmitting the generated intermediate data to a raster image generation unit configured to generate a raster image from the intermediate data each time the intermediate data is generated in the generating,
wherein the intermediate data includes edge information and filling information corresponding to an area surrounded by respective edges, the determining further determines units of generation for the edge information and units of generation for the filling information, and the determining sets the units of the generation for the filling information to be larger than the units of the generation for the intermediate data in a case where the intermediate data generated in the generating is large.

11. A non-transitory computer-readable medium that stores a program for causing a computer to function as the respective units of the image processing apparatus according to claim 1.
